(19) United States
(12) Patent Application Publication
(10) Pub. No.: US 2015/0210579 A1
(43) Pub. Date: Jul. 30, 2015

(54) FRESH WATER GENERATION METHOD

(71) Applicant: TORAY INDUSTRIES, INC., TOKYO (JP)

(72) Inventors: Hiroaki Tanaka, Otsu-shi (JP); Hiroo Takabatake, Otsu-shi (JP); Kentaro Kobayashi, Otsu-shi (JP); Hiroaki Tanaka, Otsu-shi (JP); Naoyuki Yamashita, Otsu-shi (JP)

(73) Assignee: TORAY INDUSTRIES, INC., TOKYO (JP)

(21) Appl. No.: 14/423,847

(22) PCT Filed: Aug. 30, 2013
(86) PCT No.: PCT/JP2013/073256

§ 371 Date: Feb. 25, 2015

(30) Foreign Application Priority Data
Aug. 31, 2012 (JP) 2012-191207

(51) Int. Cl. C02F 11/02

(52) U.S. Cl. CPC C02F 11/02; C02F 2209/42; C02F 2209/08; C02F 2209/10

(57) ABSTRACT

A fresh water generation method using a fresh water-generating device. The fresh water generation method includes a first treatment process for treating sewage and wastewater using a biological treatment unit and a first solid-liquid separation unit; a second treatment process for treating sewage and wastewater with a second solid-liquid separation unit; and a first detection process for detecting the treatment capacity level of the biological treatment unit; and which adjusts the volume of sewage and wastewater treated with the second treatment process on the basis of the results of the first detection process.

### CROSS REFERENCE TO RELATED APPLICATIONS

This is the U.S. National Phase application of PCT International Application No. PCT/JP2013/073256, filed Aug. 30, 2013, and claims priority to Japanese Patent Application No. 2012-191207, filed Aug. 31, 2012, the disclosures of each of these applications being incorporated herein by reference in their entireties for all purposes.

### FIELD OF THE INVENTION

The present invention relates to a fresh water generation method for generating treated water by treating sewage and wastewater or treatment subject water as sewage and wastewater that has been previously subjected to a solid-liquid separation treatment. Fresh water (treated water) obtained by the fresh water generation method according to the present invention may be used as domestic and commercial water or as industrial water, or may be provided as effluent water having a low impact on environmental pollution.

### BACKGROUND OF THE INVENTION

In the sewage and wastewater treatment where a large amount of sewage water intermittently enters, in particular, in the combined sewage and wastewater treatment in the rain, sewage water in an amount exceeding a maximum cleaning capacity of a biological reaction treatment tank, that is, a treatment capacity of the biological reaction treatment tank, enters the biological reaction treatment tank. The exceeding amount of sewage water then flows out of the biological reaction treatment tank into rivers and such, without being sufficiently cleaned, that is, without satisfying a standard value of the quality of effluent water considering environmental pollution. In this case, there is a problem that an environmental load is increased.

In order to solve this problem, there are proposed a number of approaches for changing conditions for the sewage water treatment by an alternative sewage water treatment device provided in parallel with the biological reaction treatment tank (a secondary sewage water treatment method) depending on an amount of sewage water entering the biological reaction treatment tank with respect to a treatable water amount of the biological reaction treatment tank.

As one example, Patent Document 1 proposes a method for performing a simplified treatment in the rain, by introducing influent water in an amount over the range of a normal sewage treatment capacity into a high-rate upflow filtration tank provided along a treatment line different from a biological treatment line.

Further, Patent Document 2 proposes a method for performing a treatment by introducing primary treated water, with respect to an amount of water exceeding a certain amount of a planned amount of influent sewage, into a filtration tank provided along a treatment line different from a biological treatment line. The amount of water exceeding the certain amount in this case is defined to be 1.1 to 2.0 times larger than a maximum planned amount of influent sewage.

Similarly, Patent Document 3 also proposes a method for performing a simplified treatment of water treated in a sand basin by a submerged fine filtration membrane provided adjacent to a biological treatment line and an ozone treatment, when influent water exceeds an amount of a set treatment capacity of the biological treatment.

On the other hand, Patent Document 4 proposes a method in which a film that is employed in sewage and wastewater treatment facilities in order to deal with overflow water in the rain is used not only in the rain, but also on fine days. This method aims at an efficient operation of the facilities.

### PATENT DOCUMENTS

Patent Document 1: JP2007-038092A
Patent Document 2: JP2005-218991A
Patent Document 3: JP2002-011467A
Patent Document 4: WO2011/136043A1

### SUMMARY OF THE INVENTION

Even if the technique proposed in Patent Document 1, Patent Document 2, Patent Document 3, or Patent Document 4 is employed, there is a case in which sewage water that does not satisfy the quality of effluent water is discharged into the environment, and there is a situation where stability of a cleaning treatment of wastewater is not sufficiently ensured. An object of the present invention is to provide a new fresh water generation method which is aimed at improving such a situation as much as possible.

The techniques proposed in Patent Document 1, Patent Document 2, Patent Document 3, and Patent Document 4 relate to a technique of the sewage and wastewater treatment for dealing with a case in which an amount of influent water to treatment facilities increases due to rain or the like, and exceeds an original treatable water amount for sewage and wastewater. Therefore, these documents neither disclose nor suggest an alternative secondary treatment method in a case in which the treatment capacity of the biological treatment tank in itself changes due to circumstances such as a disaster, an unexpected accident, and a trouble in an operation.

Therefore, in a case in which an amount of sludge or a level of a sludge activity within the biological treatment tank changes, and the biological treatment is not sufficiently performed to sewage and wastewater, there is a concern that effluent water that does not satisfy a standard for a water quality is discharged into the environment. Thus, there is a need for considerations on, depending on conditions of the activated sludge such as an amount of sludge or a level of a sludge activity within the biological treatment tank, a treatment method alternative to the biological treatment for purifying sewage and wastewater into water of a quality that may be discharged to rivers and such, as well as a control method for controlling a load to both the biological treatment and the alternative treatment.

Further, even when the biological treatment tank is normally functioning in the sewage and wastewater treatment, there is a case in which due to various reasons such as deterioration in the quality of influent water, there is a concern that the quality of the treated water may deteriorate or water not meeting the standard for the quality of effluent water may be discharged to rivers and such. Therefore, there is a need for considerations on, depending on the quality of the treated water, a treatment method alternative to the biological treatment for purifying sewage and wastewater into water of the quality that may be discharged to rivers and such, as well as a control method for controlling a load to both the biological treatment and the alternative treatment.

However, when the biological treatment and the alternative treatment are performed in parallel, there is generally a case in which the quality of water treated by the alternative treatment is poorer than the quality of biologically treated water. Accordingly, as a whole, it is not necessarily possible to purify the water into water of a quality that may be discharged to rivers and such. Therefore, there is a need for a consideration on a control method for maintaining the quality of effluent water discharged to rivers and such by mixing the biologically treated water with the water treated by the alternative treatment.

Thus, the present invention makes it possible to provide a fresh water generation method capable of controlling the quality of effluent water discharged to rivers and such to be an appropriate level in sewage and wastewater treatment facilities where a large amount of sewage water enters intermittently, by adjusting an amount of biologically treated water and an amount of water treated by an alternative treatment, and/or adjusting mixing of the biologically treated water and the water treated by the alternative treatment, depending on a change of a load to activated sludge within a biological treatment tank and levels of sludge activity and the quality of treated water.

In order to solve the above problems, the present invention includes the following.

A fresh water generation method for generating treated water by treating sewage and wastewater or treatment subject water as sewage and wastewater that has been previously subjected to a solid-liquid separation treatment, the method comprising:

(a) using a fresh water-generating device including a biological treatment unit configured to treat the treatment subject water that has entered with activated sludge to discharge biologically treated water, a first solid-liquid separation unit configured to treat the biologically treated water that has entered with a solid-liquid separation element to discharge first treated water, and a second solid-liquid separation unit configured to treat the treatment subject water that has entered with a solid-liquid separation element to discharge second treated water;

(b) performing a first detection process for detecting a level of a treatment capacity of the biological treatment unit, and/or a second detection process for detecting either a level of a quality of the first treated water and a level of a quality of the second treated water, or a level of a quality of third treated water as a mixture of the first treated water and the second treated water; and

(c) controlling a volume of the treatment subject water to be treated by the second solid-liquid separation unit based on the level of the treatment capacity of the biological treatment unit detected in the first detection process, and/or controlling an amount of the second treated water to be mixed with the first treated water based on the level of the quality of the treated water detected in the second detection process.

In the present invention, it is preferable that the detection of the level of the treatment capacity of the biological treatment unit in the first detection process is made by detecting a level of treatment activity of the activated sludge, and when the detected level of the treatment activity of the activated sludge fails to satisfy a standard value, an amount of the treatment subject water entering the second solid-liquid separation unit is increased so that the standard value is satisfied.

In the present invention, it is preferable that the detection of the level of the treatment capacity of the biological treatment unit in the first detection process is made by detecting a level of a quality of the biologically treated water, and when the detected level of the quality of the biologically treated water fails to satisfy a standard value, an amount of the treatment subject water entering the second solid-liquid separation unit is increased so that the standard value is satisfied.

In the present invention, it is preferable that the detection of the level of the treatment capacity of the biological treatment unit in the first detection process is made by detecting a level of treatment activity of the activated sludge, and as well as by detecting a level of a quality of the biologically treated water, and when the detected level of the treatment activity of the activated sludge and the detected level of the quality of the biologically treated water fail to satisfy a standard value, an amount of the treatment subject water entering the second solid-liquid separation unit is increased so that the standard value is satisfied.

In the present invention, it is preferable that the detection of the level of the quality of the treated water in the second detection process is made by detecting a level of a quality of the third treated water as the mixture of the first treated water and the second treated water, and when the detected level of the quality of the third treated water fails to satisfy a standard value, the amount of the second treated water to be mixed with the first treated water is controlled so that the standard value is satisfied.

In the present invention, it is preferable that when the detected level of the quality of the third treated water is attributed to a suspended matter in the third treated water, the amount of the second treated water to be mixed with the first treated water is increased, and when the detected level of the quality of the third treated water is attributed to a dissolved matter in the third treated water, the amount of the second treated water to be mixed with the first treated water is decreased.

In the present invention, it is preferable that the detection of the level of the treatment activity of the activated sludge is made by detecting a level of at least one of BOD sludge loading and OUR of the activated sludge, and when the detected level of the at least one of BOD sludge loading and OUR exceeds a standard value, the amount of the treatment subject water entering the second solid-liquid separation unit is increased so that the detected level does not exceed the standard value.

In the present invention, it is preferable that the detection of the level of the treatment capacity of the biological treatment unit in the first detection process is made by detecting one or more of BOD, COD, SS concentration, T-P concentration, T-N concentration, and turbidity of the biologically treated water, and when a detected level of the one or more of BOD, COD, SS concentration, T-P concentration, T-N concentration, and turbidity exceeds a standard value, the amount of the treatment subject water entering the second solid-liquid separation unit is increased so that the detected level does not exceed the standard value.

In the present invention, it is preferable that the detection of the level of the quality of the treated water in the second detection process is made by detecting one or more of BOD, COD, SS concentration, T-P concentration, T-N concentration, and turbidity of the treated water, and the amount of the second treated water to be mixed with the first treated water is controlled so that the detected level of the one or more of BOD, COD, SS concentration, T-P concentration, T-N concentration, and turbidity satisfies a standard value.

In the present invention, it is preferable that a part of the second treated water is temporarily reserved according to the level of the quality of the third treated water, and the temporarily reserved second treated water is mixed with the first treated water according to a change in the level of the quality of the third treated water.

In the present invention, it is preferable that the solid-liquid separation element of the second solid-liquid separation unit is made of a filtration membrane.

According to the present invention, it is possible to purify the treatment subject water appropriately without depending simply on an amount of influent water by controlling, taking an activated sludge condition and/or the level of the quality of the treated water of the biological treatment unit as an indicator, an amount of water in both the treatments including the biological treatment (treatment of the treatment subject water by the biological treatment unit) and the alternative treatment (treatment of the treatment subject water by the second solid-liquid separation unit). Further, even when both the treatments are performed in parallel, it is possible to achieve a quality of effluent water that satisfies a standard by controlling the mixing ratio between both of the treated water.

Moreover, according to the present invention, no extra load need be placed on both the treatments even in circumstances such as a disaster, an unexpected accident, and a trouble in an operation, and this facilitates repair and maintenance of the treatment facilities.

### BRIEF DESCRIPTION OF THE DRAWINGS

FIG. 1 shows a schematic side view illustrating one example of a fresh water-generating device for implementing the fresh water generation method of the present invention.

FIG. 2 shows a chart showing changes of an amount of BOD sludge loading, an amount of biologically treated water, and an amount of second treated water during the treatment period in which treatment subject water is treated according to Example 1.

FIG. 3 shows a chart showing changes of OUR, an amount of biologically treated water, and an amount of second treated water during the treatment period in which treatment subject water is treated according to Example 2.

FIG. 4 shows a chart showing changes of a BOD concentration, an amount of biologically treated water, and an amount of second treated water during the treatment period in which treatment subject water is treated according to Example 3.

FIG. 5 shows a chart showing changes of a T-N concentration of first treated water, a T-N concentration of second treated water, a T-N concentration of third treated water (mixed water of the first treated water and the second treated water), and amounts of the treated water during the treatment period in which treatment subject water is treated according to Example 4.

### DETAILED DESCRIPTION OF EMBODIMENTS OF THE INVENTION

A fresh water generation method according to the present invention will be described with reference to embodiments and the drawings.

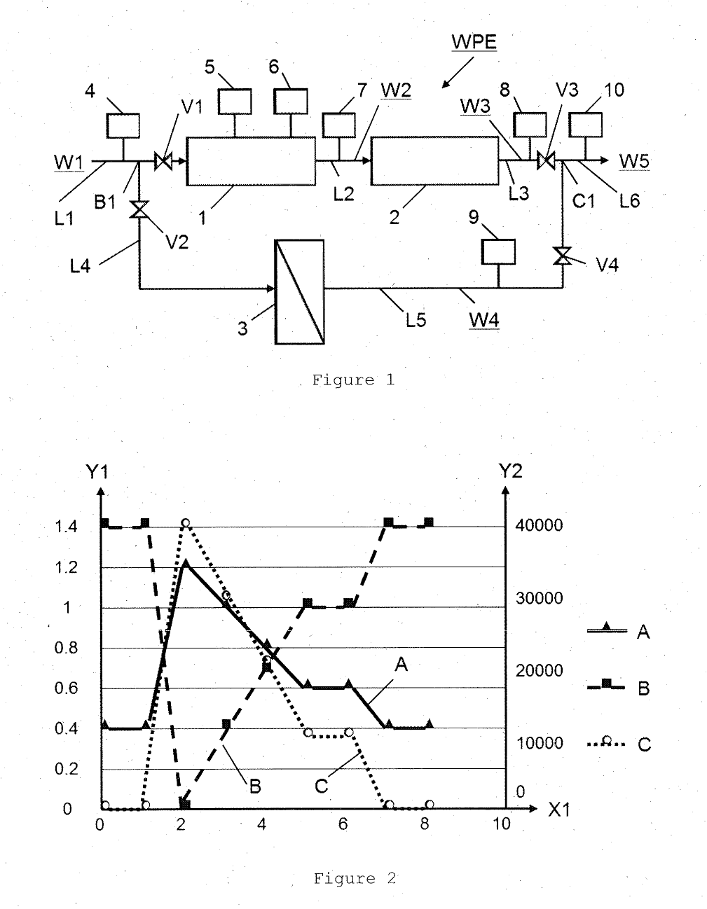

FIG. 1 shows a schematic side view illustrating one example of a fresh water-generating device for implementing the fresh water generation method of the present invention. Afresh water-generating device WPE illustrated in FIG. 1 is provided with a biological treatment unit 1, a first solid-liquid separation unit 2, and a second solid-liquid separation unit 3.

The biological treatment unit 1 is connected with a treatment subject water flow line L1 for allowing sewage and wastewater or treatment subject water W1 as sewage and wastewater that has been previously subjected to solid-liquid separation to flow into the biological treatment unit 1 from outside of the fresh water-generating device WPE. Further, the biological treatment unit 1 is connected with a biologically treated water flow line L2 for allowing biologically treated water W2 obtained through a treatment to the influent treatment subject water W1 with activated sludge to flow out.

The first solid-liquid separation unit 2 is connected with a downstream end of the biologically treated water flow line L2 derived from the biological treatment unit 1. Further, the first solid-liquid separation unit 2 is connected with a first treated water flow line L3 for allowing first treated water W3 obtained through a treatment to the influent biologically treated water W2 with a solid-liquid separation element to flow out.

The second solid-liquid separation unit 3 is connected with a downstream end of a treatment subject water flow line L4 branched at a branch point B1 from the treatment subject water flow line L1. Further, the second solid-liquid separation unit 3 is connected with a second treated water flow line L5 for allowing second treated water W4 obtained through a treatment to the influent treatment subject water W1 with a solid-liquid separation element to flow out. The downstream end of the second treated water flow line L5 is coupled to the first treated water flow line L3 at a connection point C1. From the connection point C1, a discharge line L6 for treated water W5 is directed outside of the fresh water-generating device WPE. The treated water W5 takes one of three patterns: one containing only the first treated water W3, another containing only the second treated water W4, and mixed water of the first treated water W3 and the second treated water W4. The mixed water is often referred to as third treated water W5.

The treatment subject water flow line L1 is provided with a valve V1 at a position between the branch point B1 and the biological treatment unit 1. The valve V1 is for adjusting an amount of water flowing through this position. The treatment subject water flow line L4 is provided with a valve V2 at a position between the branch point Bland the second solid-liquid separation unit 3. The valve V2 is for adjusting an amount of water flowing through this position. The first treated water flow line L3 is provided with a valve V3 at a position between the first solid-liquid separation unit 2 and the connection point C1. The valve V3 is for adjusting an amount of water flowing through this position. The second treated water flow line L5 is provided with a valve V4 at a position between the second solid-liquid separation unit 3 and the connection point C1. The valve V4 is for adjusting an amount of water flowing through this position.

By operating the valve V3 and the valve V4, it is possible to make the treated water W5 flowing through the discharge line L6 either contain only the first treated water W3, contain only the second treated water W4, or be the third treated water (mixed water) as a mixture of the first treated water W3 and the second treated water W4.

On an upstream side of the branch point B1, the treatment subject water flow line L1 is connected with a BOD concentration measurement device 4 configured to measure a value of a BOD concentration of the treatment subject water W1. The biological treatment unit 1 is connected with an MLSS measurement device 5 configured to measure a value of an MLSS indicating a concentration of suspended solids in the activated sludge, and an OUR measurement device 6 configured to measure a value of OUR indicating an oxygen uptake rate per unit mass of an activated sludge.

The biologically treated water flow line L2 is connected with a biologically treated water quality measurement device 7 configured to measure a quality (e.g., BOD concentration) of the biologically treated water W2 flowing through this line. The first treated water flow line L3 is connected with a first treated water quality measurement device 8 configured to measure a quality (e.g., T-N concentration) of the first treated water W3 flowing through this line. The second treated water flow line L5 is connected with a second treated water quality measurement device 9 configured to measure a quality (e.g., T-N concentration) of the second treated water W4 flowing through this line. The discharge line L6 is connected with a mixed water quality measurement device 10 configured to measure a quality (e.g., T-N concentration) of the third treated water (mixed water) W5, if the third treated water (mixed water) W5 flows through this line.

The fresh water generation method for generating the treated water W5 by treating the treatment subject water W1 in the fresh water-generating device WPE illustrated in FIG. 1 is as follows.

Sewage and wastewater or the treatment subject water W1 as sewage and wastewater previously subjected to a solid-liquid separation treatment that has entered the fresh water-generating device WPE is subjected to a treatment of removal of organic substances, nitrogen, or the like from the treatment subject water W1 through the biological treatment unit 1 containing activated sludge to give the biologically treated water W2. The biologically treated water W2 is subjected to a treatment of removal of solids such as the activated sludge from the biologically treated water W2 though the first solid-liquid separation unit 2 to give the first treated water W3. The first treated water W3 is discharged in the environment such as rivers. Hereinafter, this process may often be referred to as a first treatment process.

The fresh water-generating device WPE is characterized by the second solid-liquid separation unit 3 capable of removing solids contained in the treatment subject water W1 to give the second treated water W4. A flow of treating the treatment subject water using the second solid-liquid separation unit 3 is as follows.

When a treatment capacity of the biological treatment unit 1 declines due to deterioration of conditions of the activated sludge caused by a disaster or a trouble in the operation of the fresh water-generating device WPE, or when deterioration of a quality of the biologically treated water W2 is detected due to various reasons such as deterioration of a quality of the treatment subject water W1, an amount of the treatment subject water W1 entered the biological treatment unit 1 and to be treated in the first treatment process decreases, and a larger amount of water is transported to the second solid-liquid separation unit 3. The treatment subject water W1 transported to the second solid-liquid separation unit 3 without going through the biological treatment unit 1 becomes the second treated water W4 through the second solid-liquid separation unit 3. Hereinafter, this process may often be referred to as a second treatment process.

In addition, the biologically treated water quality measurement device 7 is provided at a halfway point between the biological treatment unit 1 and the first solid-liquid separation unit 2, the first treated water quality measurement device 8 is provided at a halfway point between the first solid-liquid separation unit 2 and a mixing point of the first treated water W3 and the second treated water W4 (the connection point C1), the second treated water quality measurement device 9 is provided at a halfway point between the second solid-liquid separation unit 3 and the mixing point of the first treated water W3 and the second treated water W4 (the connection point C1), and the mixed water quality measurement device 10 is provided on a downstream side of the mixing point of the first treated water W3 and the second treated water W4 (the connection point C1). With this, it is possible to monitor qualities of water at the respective points.

According to measurement results of levels of the water quality by the first treated water quality measurement device 8 and the second treated water quality measurement device 9, or according to a measurement result of a level of the water quality by the mixed water quality measurement device 10, the mixing ratio between the first treated water W3 and the second treated water W4 is adjusted so that the discharged treated water W5 satisfies a standard for water quality specified for the environment into which the water is to be discharged.

Preferably, sewage and wastewater handled as raw water (treatment subject water) for the biological treatment unit 1 and the second solid-liquid separation unit 3 is previously subjected to the solid-liquid separation treatment to remove any large solid matter.

As means for the solid-liquid separation treatment, a sand basin, a primary sedimentation tank, or a combination of these is preferably used. It is possible to use means such as dissolved air flotation, where a matter having a specific gravity closer to that of water is separated by being adsorbed to microscopic bubbles and caused to float on the surface of the water. At this time, in order to improve precipitability and floatability, it is also preferable to add an inorganic or polymeric flocculating agent such as polyaluminum chloride (hereinafter abbreviated to PAC) or ferric chloride (hereinafter abbreviated to FeCl₃).

As the biological treatment unit 1, an activated sludge tank is preferably used. By performing aeration with the biological treatment unit 1, it is possible to decompose and remove soluble organic components and ammoniacal nitrogen in the water treated with microbes in the activated sludge. Further, it is preferable to provide an anoxic tank and an anaerobic tank within the biological treatment unit 1 to improve removability of nitrogen and phosphorus.

A method for the biological treatment is not particularly limited, and examples thereof include a step aeration process, an oxygen activated sludge process, an oxidation ditch process, and an extended aeration process. However, considering the fact that sewage and wastewater to be treated goes through the solid-liquid separation treatment, it is preferable to employ one of a conventional activated sludge process, a step aeration process, and an oxygen activated sludge process as the method of the biological treatment performed by the biological treatment unit 1.

As the first solid-liquid separation unit 2, a final sedimentation tank or membrane separation is used. However, in the aim of removing polluted sludge from the biologically treated water at low energy, it is preferable to use a final sedimentation tank in a normal sewage and wastewater treatment.

In the final sedimentation tank, the activated sludge that has flowed out is removed by gravity sedimentation. At this time, the solid-liquid separation may be promoted by a flocculating agent such as PAC or FeCl₃.

There is a case in which a membrane bioreactor (MBR) is used where the biological treatment unit 1 and the solid-liquid separation unit 2 are combined. The MBR is a process for performing the solid-liquid separation by submerging a membrane within the biological treatment unit 1 and performing suction filtration. The MBR is effective when it is necessary to acquire a treatment device with a small space, as it is not necessary to ensure an area for the final sedimentation tank when the MBR is used.

As the second solid-liquid separation unit 3, a membrane separation device, a high-speed coagulation sedimentation device, a high-speed filtration device, a centrifugal separation device, or a dissolved air flotation device may be employed. However, it is preferable to use a membrane separation device as it is possible to generate treated water with which an environmental load may be reduced.

Examples of the type of the membrane used in this membrane separation device include a reverse osmotic membrane, a nanofiltration membrane, an ultrafiltration membrane, and a fine filtration membrane. When water with high turbidity is supposed to be the treatment subject water, it is preferable to use a fine filtration membrane or an ultrafiltration membrane whose pore diameter is relatively large.

The fine filtration membrane that is preferably used in the present invention is a membrane having an average micropore diameter from 0.01 μm to 5 mm. The ultrafiltration membrane that is preferably used in the present invention is a membrane having a molecular weight cut off from 1,000 Da to 200,000 Da. The molecular weight cut off is an indicator of the size of the pore diameter in place of the average micropore diameter, when it is difficult to measure the micropore diameter on a surface of a membrane using an electron microscope or the like.

In order to treat sewage and wastewater containing a large amount of solids such as turbidity components for which the fresh water generation method according to the present invention is expected to be employed, it is preferable to use an ultrafiltration membrane having a molecular weight cut off from 1,000 Da to 200,000 Da, whose micropores are hardly clogged with the suspensoid or the like. In general, as the molecular weight cut off decreases, transmissibility of a membrane per unit area deteriorates. Therefore, it is preferable to use an ultrafiltration membrane having a molecular weight cut off from 1,000 Da to 200,000 Da. It is more preferable to use an ultrafiltration membrane having a molecular weight cutoff from 100,000 Da to 200,000 Da.

The material of the membrane is not particularly limited. When an organic material is used, polyethylene, polypropylene, polyacrylonitrile, an ethylene-tetrafluoroethylene copolymer, polychlorotrifluoroethylene, polytetrafluoroethylene, polyvinyl fluoride, tetrafluoroethylene-hexafluoropropylene copolymer, a chlorotrifluoroethylene-ethylene copolymer, polyvinylidene fluoride, polysulfone, polyether sulfone, cellulose acetate, or the like may be used. When an inorganic material is used, ceramic or the like may be used. Among these, it is preferable to use a membrane made of an organic material containing fluorine or a ceramic material, in view of the film strength and chemical resistance.

The membrane may be in the form of a hollow yarn, spiral, tubular, or in the form of a flat membrane. Further, as the filtration method, dead-end filtration and cross-flow filtration are known, and a manner of passing water to the filtration membrane may be of an internal pressure type, an external pressure type, or the like. These methods may be used differently depending on circumstances and needs.

However, no matter what types of a membrane, a module, and a filtration method are used in the treatment, it is preferable that a level of the quality of the second treated water W4 is equal to or above a level of the quality of the first treated water W3.

It is also preferable to provide solid removing means such as a strainer for removing large-sized solids at a stage before the second solid-liquid separation unit 3. Further, it is also preferable to employ an efficient treatment method for reducing micro-pollution materials in the water by adding a flocculating agent such as PAC to raw water (the treatment subject water W1) in the unit to form a floc, at the stage before the second solid-liquid separation unit 3.

Next, a method for determining an amount of water to be treated by the second solid-liquid separation unit 3 will be described.

The amount of water to be treated in the treatment of the treatment subject water W1 by the second solid-liquid separation unit 3, that is, in the second treatment process is determined based on a status of activity of polluted sludge in the biological treatment unit 1 and/or the level of the quality of the biologically treated water W2.

Here, the status of activity of the polluted sludge in the biological treatment unit 1 may be quantitatively measured and calculated, and it is preferable to determine the status based on BOD sludge loading and/or OUR that are typical indicators for grasping the status of activity of the polluted sludge and a load to the polluted sludge.

The BOD sludge loading is defined by the following expression.

[(amount of influent water to biological treatment unit 1 per day×average BOD of influent water)/(volume of biological treatment unit 1×concentration of activated sludge (MLSS))] Expression:

By measuring an amount of influent water to the biological treatment unit 1, an average BOD concentration of the influent water, and an MLSS concentration, it is possible to learn a change in the BOD sludge loading. In the present invention, in particular, it is preferable to determine the change in the BOD sludge loading by monitoring the average BOD concentration of the influent water to the biological treatment unit 1 or the MLSS concentration within the biological treatment unit 1.

As a method of monitoring, the BOD concentration measurement device 4 and the MLSS measurement device 5 may be either online or offline, but it is preferable to operate them online for the purpose of operational management. However, it is more preferable to provide a configuration that can be controlled offline in case the online control is impossible at the time of a disaster or in a trouble in the operation.

For the measurement of the BOD concentration, testing methods for industrial wastewater prescribed in JIS-K-0102 are typically used. However, the measurement method has a problem such as requiring five days for the measurement. Therefore, for the BOD concentration measurement device 4, it is preferable to use a biochemical oxygen demands (BODS) measuring instrument (JIS-K-3602) based on a microbe electrode method with which the BOD concentration may be measured on a real-time basis.

Further, while the MLSS concentration is typically measured by the method prescribed in JIS-K-0102-14.1 “suspended solids,” it is preferable to use a method employing an optical scheme for the MLSS measurement device 5 in the present invention. While the MLSS measurement device 5 may be either of a submerged type or a sampling type, it is preferable to employ a submerged type for the purpose of management as this type facilitates monitoring.

An increase in the BOD concentration or a decrease in the MLSS concentration causes an increase in the BOD sludge loading of the biological treatment unit 1. If the BOD sludge loading exceeds a previously set maximum value for the BOD sludge loading, the treatment subject water W1 in an amount corresponding to an excess of the BOD sludge loading is transported to the second solid-liquid separation unit 3 through a bypass (the treatment subject water flow line L4) according to the value of the BOD sludge loading, and treated there.

If, during a time in which the water in the amount corresponding to the excess of the BOD sludge loading is treated by the second solid-liquid separation unit 3, the influent BOD concentration or the MLSS concentration in the biological treatment unit 1 is resumed, and the BOD sludge loading decreases and the BOD sludge loading drops below the maximum value for the BOD sludge loading, a state in which the treatment subject water W1 in an amount corresponding to the reduced amount is treated by the biological treatment unit 1 is maintained.

It is also preferable to use OUR, in addition to the BOD sludge loading, as an indicator of the state of the activated sludge in the biological treatment unit 1. OUR stands for the oxygen uptake rate per unit mass of the activated sludge. Based on the value of OUR, it is possible to determine an amount of the polluted sludge and quantitate the status of activity.

As a method of measuring OUR, an electrode method is typically used. In the present invention, the electrode method may be employed for the measurement. A method of measuring OUR by the electrode method prescribed in “Method of Testing Sewage” (1984, Japan Sewage Works Association) is as follows.

Instruments to be used include a dissolved oxygen meter having an oxygen sensor, a conical flask, a magnetic stirrer, a recorder, and an aeration device. A method of measurement is performed by first putting 1 L of a mixed liquid in an aeration tank into a 1-L narrow-mouthed bottle, leaving the liquid still for 10 minutes to 20 minutes, and then putting the resultant supernatant liquid into another narrow-mouthed bottle using a syphon. Then, vigorous aeration is performed using the aeration device for 5 minutes to 10 minutes so that the dissolved oxygen amount is about 5 mg/L or more, and then the liquid is stirred with precipitated polluted sludge well. The mixed liquid is filled in a 300-mL conical flask, and a sensor portion of the dissolved oxygen meter is put in the flask in a manner no air enters. Immediately, a temporal change of the dissolved oxygen is measured while the liquid is stirred with the magnetic stirrer. From a recorded sag curve, an oxygen consumption of the mixed liquid within the aeration tank per unit time is obtained by the following expression.

[OUR (oxygen uptake rate) (mg/L·h)=oxygen consumption (mg/L)/time duration (h)] Expression:

When the amount of water to be treated by the second solid-liquid separation unit 3 is controlled based on the value of OUR, if the value of OUR quantitated by the OUR measurement device 6 is under a previously set minimum value, the treatment is performed, as described above, by means of the second solid-liquid separation unit 3 for the treatment subject water W1 in an amount corresponding to an excess of biological treatment capacity.

Here, an amount of water Q₁ corresponding to an excess of biological treatment capacity is determined by the following expression, where a set value of OUR is r₀, a value of OUR quantitated by the OUR measurement device 6 is r₁, and an amount of influent water is Q₀.

[Q₁=Q₀×(r₀−r₁)/r₀] Expression:

Further, it is possible to determine an amount of the treatment subject water W1 to be treated by the second solid-liquid separation unit 3 based on the level of the quality of the biologically treated water W2 obtained from the biological treatment unit 1.

When the treatment of the treatment subject water W1 includes at least the first treatment process, an amount of water to be treated in the second treatment process is determined based on a result of the measurement detected by the biologically treated water quality measurement device 7.

On the other hand, when the treatment of the treatment subject water W1 is performed entirely in the second treatment process, it is not possible to find a result of the measurement detected by the biologically treated water quality measurement device 7 in the first treatment process. In this case, an amount of water to be then treated in the first treatment process and the second treatment process is controlled taking a status of activity of polluted sludge in the biological treatment unit 1 as an indicator.

In this case, if the level of the water quality measured by the biologically treated water quality measurement device 7 exceeds a set standard for the water quality, the treatment subject water in an amount at least sufficient for the quality of the biologically treated water to satisfy the previously set standard is transported to the second solid-liquid separation unit 3 by the bypass (the treatment subject water flow line L4) from the branch point B1 before the biological treatment unit 1 and treated.

In this manner, the treated water W5 treated in the first treatment process and the second treatment process is purified and then discharged to rivers and such. In this case, the quality of the water treated by the second solid-liquid separation unit 3 in the second treatment process, that is, the quality of the second treated water W4 is, in many cases, expected to be poorer than the quality of the first treated water W3 in major items for a standard for the quality of effluent water, especially BOD, COD, and T-N, relating to a dissolved matter in the treated water.

Thus, it is possible to convert the water to be treated to water where items for the water quality detected by the mixed water quality measurement device 10 satisfy the standard for the quality of effluent water by mixing the second treated water W4 in the first treated water W3 at an appropriate mixing ratio based on the results of the measurement by the first treated water quality measurement device 8 and the second treated water quality measurement device 9, or the mixed water quality measurement device 10. Here, the items for the water quality as a standard in controlling the mixing ratio do not necessarily have to be the items for the water quality of the biologically treated water W2 that is used as the standard in selecting the second treatment process.

When an amount of the second treated water W4 to be mixed with the first treated water W3 is determined based on the results of the measurement by the first treated water quality measurement device 8 and the second treated water quality measurement device 9, the mixing ratio is determined based on an amount of the first treated water, a measured value of the quality of the first treated water, an amount of the second treated water, and a measured value of the quality of the second treated water. Specifically, the amount of the second treated water is adjusted to a level at which a value obtained by an expression: [(amount of first treated water×measured value of quality of first treated water+amount of second treated water×measured value of quality of second treated water)/(amount of first treated water+amount of second treated water)] does not exceed the previously determined standard value, and the quality of the water after mixing is monitored by the mixed water quality measurement device 10.

Here, if the second treated water W4 that is not mixed with the first treated water W3 satisfies an effluent standard, the second treated water W4 is discharged as it is, and if not, an intermediate tank (not depicted) may be provided between the second treated water quality measurement device 9 and a mixing point (the connection point C1), and the water may be reserved in order to be mixed with the first treated water that comes later, or the biologically treated water or the influent sewage and wastewater. In this case, it is preferable that the second treated water quality measurement device 9 is capable of measuring the quality of the water reserved in the intermediate tank.

Further, it is also possible to determine the amount of the second treated water W4 to be mixed with the first treated water W3 based only on the result of the measurement by the mixed water quality measurement device 10. At this time, when a membrane treatment or the like is performed in the second treatment process, the second treated water W4 will have an extremely low suspended matter concentration, but its dissolved matter concentration may not be expected to be as low as that of the biologically treated water W2.

Therefore, when an item measured by the mixed water quality measurement device 10 is the suspended matter, the amount of the second treated water W4 to be mixed is increased until the standard value is met. On the other hand, when an item measured by each of the water quality measurement devices is the dissolved matter, the amount of the second treated water W4 to be mixed is decreased until the standard value is met. In this manner, conversion to mixed water of a quality not exceeding the previously determined standard is made possible. In this case, it is advantageously possible to adjust an amount of the second treated water W4 to be mixed only with prescribed measurement items and determination on whether or not the standard is exceeded without incorporating complicated calculation.

Here, with regard to definition of a suspended form and a dissolved form, the suspended form (particle) typically refers to a component that, when filtered with a filtration membrane having a pore diameter from 0.45 μm to 1 μm, does not pass the filtration membrane, and the dissolved form (soluble component) typically refers to a component contained in a filtrate that has passed the filtration membrane having a pore diameter from 0.45 μm to 1 μm. However, there is minimal possibility that all of the items for the water quality fall under the category of the dissolved form. Therefore, in the present invention, it is necessary to define an item for the water quality to which the dissolved matter corresponds.

The level of the water quality measured by the biologically treated water quality measurement device 7, the first treated water quality measurement device 8, the second treated water quality measurement device 9, and the mixed water quality measurement device 10 is represented by items taken as standards when the treated water W5 is discharged into the environment such as rivers, lakes and marshes. Preferable items include an organic substance concentration indicator such as BOD and chemical oxygen demand (COD), suspended solids (SS) concentration, total phosphorus (T-P) concentration, total nitrogen (T-N) concentration, turbidity, and coliform group count as a hygienic indicator.

Among these, BOD, COD, and T-N are particularly preferable in view of an extent of the load to environment and ease of monitoring of the water quality. However, virus concentration, heavy metal concentration, and trace chemical pollutant concentration that are not included in the above standard items may also be taken as indicators. Here, the suspended matter is represented by SS concentration, turbidity, the coliform group count, or the like, and the dissolved matter is represented by BOD, COD, T-P, T-N, or the like.

Among the items to be measured by the biologically treated water quality measurement device 7, the first treated water quality measurement device 8, the second treated water quality measurement device 9, and the mixed water quality measurement device 10, the method of measuring BOD is as described above.

In order to measure COD, a titration method based on “testing methods for industrial wastewater” prescribed in JIS-K-0102 is typically used. In the present invention, when employing automatic monitoring, it is preferable to use a COD automatic measuring instrument manufactured based on the standard of “chemical oxygen demand (COD) automatic measuring instrument” prescribed in JIS-K-0806.

In order to measure the SS concentration, similarly to the measurement of the MLSS concentration, the method prescribed in “suspended solids” of JIS-K-0102-14.1 is typically used. However, in the present invention, it is preferable to use an optical method.

In order to measure the T-P concentration, potassium peroxydisulfate decomposition, nitric acid-perchloric acid decomposition, or nitric acid-sulfuric acid decomposition based on “Testing methods for industrial wastewater” prescribed in JIS-K-0102 is typically used. In the present invention, it is preferable to use a fully automatic device based on JIS-K-0102.

In order to measure the T-N concentration, a summability method or an ultraviolet spectrophotometric method based on “Testing methods for industrial wastewater” prescribed in JIS-K-0102 is typically used. In the present invention, it is preferable to use a fully automatic device based on JIS-K-0102.

In order to measure turbidity, a method based on “Testing methods for industrial wastewater” prescribed in JIS-K-0102 is typically used. In the present invention, it is preferable to perform automatic monitoring based on “automatic turbidity measuring instrument” prescribed in JIS-K-0801-1986.

In order to measure coliform group count, it is preferable to perform monitoring based on “Testing methods for coliform groups in water and drainage water” prescribed in JIS-K-0350-20-10. As the automatic monitoring is difficult, when taking the coliform group count as an indicator item, it is preferable to manually measure appropriately sampled water based on JIS-K-0350-20-10.

As the effluent standard of the items for the water quality varies greatly depending on countries and areas, it is necessary to change a standard to be set for the value measured by the mixed water quality measurement device 10 depending on circumstances of the usage environment.

In such a situation, it is preferable that standards are set within the range of 10 mg/L to 120 mg/L for BOD, the range of 40 mg/L to 250 mg/L for COD, the range of 10 mg/L to 150 mg/L for SS concentration, the range of 0.5 mg/L to 12 mg/L for T-P concentration, the range of 10 mg/L to 60 mg/L for T-N concentration, and the range of 400 cells/cm³ to 10,000 cells/cm³ for coliform group count.

### Example 1

In the fresh water-generating device WPE illustrated in FIG. 1, a method of treating the treatment subject water W1 when the treatment capacity of the biological treatment unit 1 decreases and the BOD sludge loading increases will be described.

In this example, a continuous standard polluted sludge treatment was used as the biological reaction treatment, and a pressure-type hollow yarn ultrafiltration membrane was used as the second solid-liquid separation unit 3.

An amount of the influent treatment subject water W1, when the treatment was started, to the biological treatment unit 1 that performs the continuous standard polluted sludge treatment was 40,000 m³/day, an average influent BOD concentration was 100 mg/L, a volume of the biological treatment tank of the biological treatment unit 1 was 5,000 m³, and an MLSS concentration was 2,000 mg/L. As a result, the BOD sludge loading was 0.4 BOD-kg/MLSS-kg·day, and this value was set as the upper limit for the treatment. It should be noted that the value of the BOD sludge loading was automatically calculated based on monitoring results from the BOD concentration measurement device 4 and the MLSS measurement device 5.

Changes in the BOD sludge loading, and amounts of water to be treated by the biological treatment unit 1 and the second solid-liquid separation unit 3 during the treatment period for the treatment subject water are shown in the chart of FIG. 2.

In the chart of FIG. 2, the horizontal axis X1 represents the number of days from the start of the treatment, with a unit of [day]. The vertical axis Y1 represents the value of an amount of the BOO sludge loading, with a unit of [BOD-kg/MLSS-kg·day]. The vertical axis Y2 represents the value of an amount of the water to be treated, with a unit of [m³/day]. Further, in the chart, the line A indicates the change in the amount of the BOD sludge loading, the line B indicates the change in the amount of the biologically treated water W2, and the line C indicates the change in the amount of the second treated water W4.

After two days from the start of the treatment, the treatment capacity of the biological treatment unit 1 decreased due to a trouble in the fresh water-generating device WPE, and the BOD sludge loading became 1.2 BOD-kg/MLSS-kg·day. Thus, an entire amount of the treatment subject water W1 was caused to enter the second solid-liquid separation unit 3. With this, it was possible to prevent the sewage water from being discharged into the environment.

After three days from the start of the treatment, as the biological treatment unit 1 was restored and the BOD sludge loading decreased, an amount of the treatment subject water W1 caused to enter the biological treatment unit 2 was increased within a range in which the BOD sludge loading of the biological treatment unit 1 did not exceed 0.4 BOD-kg/MLSS-kg·day. On the seventh day from the start of the treatment, as the BOD sludge loading became 0.4 BOD-kg/MLSS-kg·day, an entire amount of 40,000 m³/day of the treatment subject water W1 was treated by the biological treatment unit 1. By switching the treatments in this manner, it was possible to prevent water with reduced quality (the treated water W5) from being discharged.

Table 1 shows data of the quality of the second treated water W3 when the treatment subject water W1 subjected to simple solid-liquid separation in a primary sedimentation tank is treated with a pressure type hollow yarn ultrafiltration membrane (the second solid-liquid separation unit 3).

TABLE 1

| | | | | | Coliform | |
|---|---|---|---|---|---|---|
| | | | | | group count | MS2 |
| | SS | BOD | COD | T-P | (MNP/ | removal |
| | (mg/L) | (mg/L) | (mg/L) | (mg/L) | 100 mL) | rate (%) |
| Effluent | 70 | 20 | 20 | 1 | 1000 | — |
| standard | | | | | | |
| Membrane | 1 or | 11 | 16 | 0.12 | 1.8 or | 99.8 |
| filtration | lower | | | | lower | |

As a pre-treatment before filtration, 100 ppm of PAC was added, and water filtered by a flux of 0.5 m/d was collected, and then various water quality analyses were performed.

SS became 0.1 mg/L or lower, and suspended solids in the treatment subject water W1 were substantially completely removed.

BOD became 11 mg/L and COD became 16 mg/L or lower, and the quality of the treated water for organic pollution materials became also lower than a general effluent standard for rivers and such.

While the removal rate for T-P with the membrane filtration alone was not high, a quality of the treated water of 0.12 mg/L was achieved by performing the membrane filtration after addition of a flocculating agent, which was sufficiently lower than a general effluent standard for rivers and such.

The water quality analyses were also performed for the coliform group count and MS2 (virus). The coliform group count decreased below a quantitative limit, and an influence on the environment was eliminated to a substantially negligible level. The viruses were removed at a removal rate of 2.2 log, that is, 99.8% of the viruses were prevented with the membrane.

In this manner, as it is possible to produce high quality water through the membrane filtration, an application of the treated water W5 as recycled water was also found in addition to the discharge.

### Example 2

In the fresh water-generating device WPE illustrated in FIG. 1, a method of treating the treatment subject water W1 when the treatment capacity of the biological treatment unit 1 decreases and OUR decreases will be described.

Also in this example, the continuous standard polluted sludge treatment was used as the biological reaction treatment, and the pressure-type hollow yarn ultrafiltration membrane was used as the second solid-liquid separation unit 3. Further, the electrode method was used for the measurement of OUR, and the state of the activated sludge was appropriately monitored.

An amount of the influent treatment subject water W1, when the treatment was started, to the biological treatment unit 1 that performs the continuous standard polluted sludge treatment was 40,000 m³/day. An oxygen uptake rate, that is, OUR required for a treatment in order to reduce the organic substance concentration indicator (BOD, COD) to a standard value or lower under this condition was 10 mg/L·h. Therefore, there was provided a system in which the treatment subject water W1 in an amount that may not be treated by the biological treatment unit 1 is discharged to the second solid-liquid separation unit 3 when OUR decreases to this value or lower.

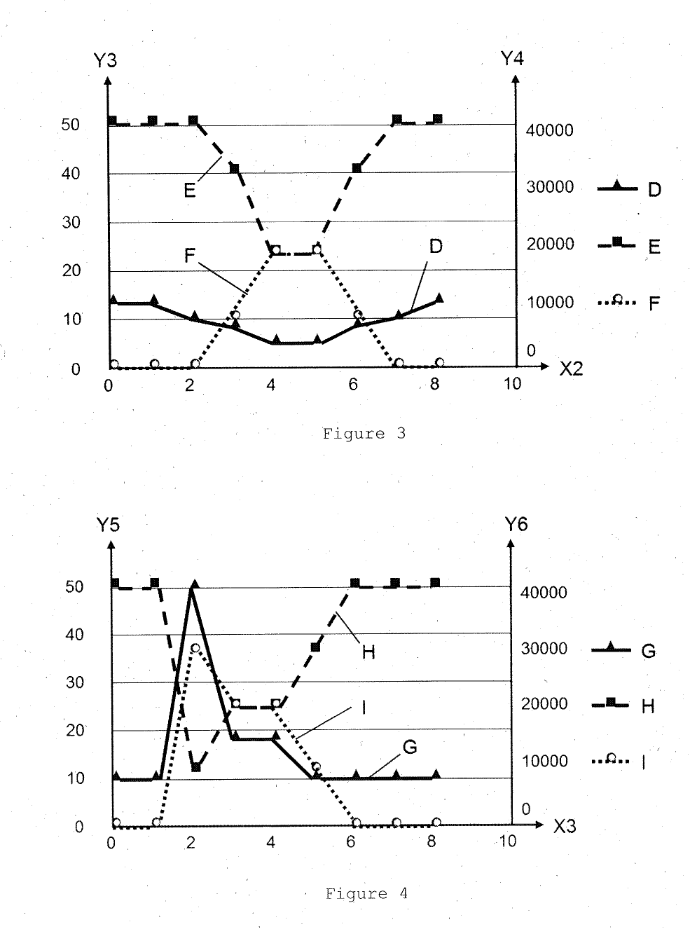

Changes in the BOD sludge loading, and amounts of water to be treated by the biological treatment unit 1 and the second solid-liquid separation unit 3 during the treatment period for the treatment subject water are shown in the chart of FIG. 3.

In the chart of FIG. 3, the horizontal axis X2 represents the number of days from the start of the treatment, with a unit of [day]. The vertical axis Y3 represents the value of OUR measured by the OUR measurement device 6 in the fresh water-generating device illustrated in FIG. 1, with a unit of [mg/L·h]. The vertical axis Y4 represents the value of an amount of the water to be treated, with a unit of [m³/day]. Further, in the chart, the line D indicates the change in OUR, the line E indicates the change in the amount of the biologically treated water, and the line F indicates the change in the amount of the second treated water.

After three days from the start of the treatment, the value of OUR became 8 mg/L·h falling below 10 mg/L·h as a standard. Therefore, based on the expression: [Q₁=Q₀×(r₀−r₁)/r₀], 8,000 m³/day of the amount Q₁ exceeding a permissible amount of the biological treatment unit 1 was caused to enter the second solid-liquid separation unit 3. With this, it was possible to prevent the sewage water from being discharged into the environment.

Then, the value of OUR showed a downward tendency, and an amount of water treated by the second solid-liquid separation unit 3 increased up to 20,000 m³/day.

After seven days from the start of the treatment, as the value of OUR increased again up to 10 mg/L·h, it was determined to treat an entire amount of 40,000 m³/day of the influent water by the biological treatment unit 1. By switching the treatments in this manner, it was possible to prevent water with reduced quality from being discharged.

### Example 3

In the fresh water-generating device WPE illustrated in FIG. 1, a method of treating the treatment subject water W1 when the level of the quality of the biologically treated water obtained by the biological treatment unit 1 changes will be described.

Also in this example, the continuous standard polluted sludge treatment was used as the biological reaction treatment, and the pressure-type hollow yarn ultrafiltration membrane was used as the second solid-liquid separation unit 3. Further, the BOD concentration was used as a standard for the water quality as an indicator for controlling the treatment process.

An amount of the influent treatment subject water W1, when the treatment was started, to the biological treatment unit 1 that performs the continuous standard polluted sludge treatment was 40,000 m³/day, and a BOD standard value of the treated water W5 allowed to be discharged was set to be 20 mg/L.

Changes in the BOD concentration measured by the biologically treated water quality measurement device 7, and the amounts of water to be treated by the biological treatment unit 1 and the second solid-liquid separation unit 3 during the treatment period for the treatment subject water are shown in the chart of FIG. 4.

In the chart of FIG. 4, the horizontal axis X3 represents the number of days from the start of the treatment, with a unit of [day]. The vertical axis Y5 represents the value of BOD concentration measured by the biologically treated water quality measurement device 7 in the fresh water-generating device illustrated in FIG. 1, with a unit of [mg/L]. The vertical axis Y6 represents the value of an amount of the water to be treated, with a unit of [m³/day]. Further, in the chart, the line G indicates the change in the BOD concentration, the line H indicates the change in the amount of biologically treated water, and the line I indicates the change in the amount of the second treated water.

After two days from the start of the treatment, the BOD concentration measured by the biologically treated water quality measurement device 7 increased up to 50 mg/L for some reason. Therefore, 20,000 m³/day of the treatment subject water W1 was caused to enter the second solid-liquid separation unit 3 so that the BOD concentration measured by the biologically treated water quality measurement device 7 was maintained at or below 20 mg/L as the standard value, and the first treated water W3 and the second treated water W4 were mixed. With this, it was possible to prevent the sewage water from being discharged into the environment.

After five days from the start of the treatment, the BOD concentration measured by the biologically treated water quality measurement device 7 decreased down to 10 mg/L. Therefore, the amount of the treatment subject water W1 caused to enter the biological treatment unit 1 was set to 30,000 m³/day, and the remaining 10,000 m³/day of the treatment subject water W1 was caused to enter the second solid-liquid separation unit 3.

After six days from the start of the treatment, the BOD concentration measured by the biologically treated water quality measurement device 7 further decreased down to 10 mg/L. Therefore, an entire amount of 40,000 m³/day of the treatment subject water W1 was treated by the biological treatment unit 1. By switching the treatments in this manner, it was possible to prevent water with reduced quality from being discharged.

### Example 4

In the fresh water-generating device WPE illustrated in FIG. 1, in order to maintain the quality of effluent water appropriately when the second treatment process is selected, it is possible to employ a method of treatment of detecting the quality of the first treated water W3 by the first treated water quality measurement device 8 and the quality of the second treated water W4 by the second treated water quality measurement device 9, and adjusting the mixing ratio of the second treated water W4 to the first treated water W3 according to the detected measured values. This method will be described.

Also in this example, the continuous standard polluted sludge treatment was used as the biological reaction treatment, and the pressure-type hollow yarn ultrafiltration membrane was used as the second solid-liquid separation unit 3. Further, the T-N concentration was used as a standard for the water quality as an indicator for controlling the treatment process.

An amount of the influent treatment subject water W1, when the treatment was started, to the biological treatment unit 1 that performs the continuous standard polluted sludge treatment was 4,000 m³/day, and a T-N concentration standard value of the mixed water (the third treated water W5) allowed to be discharged was set to be 20 mg/L.

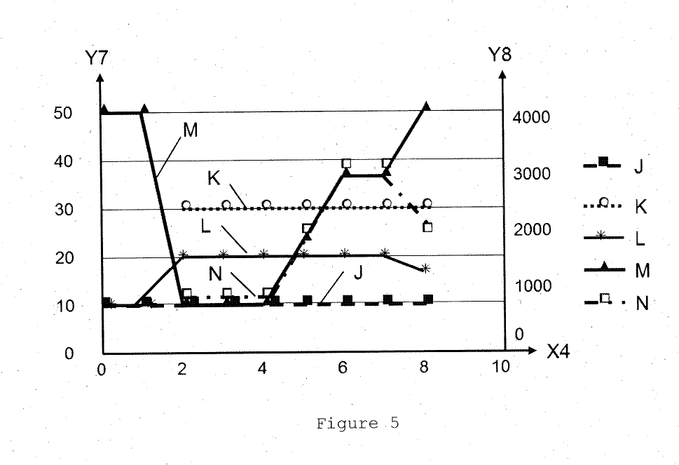

Changes in the T-N concentration measured by the first treated water quality measurement device 8, the T-N concentration measured by the second treated water quality measurement device 9, the T-N concentration measured by the mixed water quality measurement device 10, an amount of the first treated water, and an amount of the second treated water to be mixed during the treatment period for the treatment subject water are shown in the chart of FIG. 5.

The horizontal axis X4 represents the number of days from the start of the treatment, with a unit of [day]. The vertical axis Y7 represents the value of T-N concentration, with a unit of [mg/L]. The vertical axis Y8 represents the value of an amount of the water to be treated, with a unit of [m³/day]. Further, in the chart, the line J indicates the change in the T-N concentration measured by the first treated water quality measurement device 8 in the fresh water-generating device illustrated in FIG. 1, the line K indicates the change in the T-N concentration measured by the second treated water quality measurement device 9 in the fresh water-generating device illustrated in FIG. 1, the line L indicates the change in the T-N concentration measured by the mixed water quality measurement device 10 in the fresh water-generating device illustrated in FIG. 1, the line M indicates the change in the amount of the first treated water, and the line N indicates the change in the amount of the second treated water to be mixed with the first treated water.

In the beginning of the operation, as there was no problem and only the first treatment process was selected, the second detection process was not operated.

On the second day of the operation, the second treatment process was selected in accordance with the result of the first detection process. The amounts of water were 1,000 m³/day in the first treatment process and 3,000 m³/day in the second treatment process. At this time, the T-N concentration measured by the first treated water quality measurement device 8 was 10 mg/L, and that measured by the second treated water quality measurement device 9 was 30 mg/L.

A method of determining the amount of the second treated water W4 to be mixed with the first treated water W3 is expressed by the expression: [(amount of first treated water×measured value of quality of first treated water+amount of second treated water×measured value of quality of second treated water)/(amount of first treated water+amount of second treated water)].

The amount of the second treated water that may be mixed without making the T-N concentration of the mixed water exceed 20 mg/L was 1,000 m³/day, based on the calculation by the above expression, and therefore this amount was added to the first treated water W3. As a result, the T-N concentration measured by the mixed water quality measurement device 10 was 20 mg/L, and the mixed water was discharged as it is. On the other hand, 2,000 m³ of the second treated water W4 that was not mixed was reserved in the intermediate tank (not depicted) provided before the connection point C1.

Then, the similar mixing condition continued until the fourth day, and 6,000 m³ in total of the second treated water W4 was reserved in the intermediate tank.

On the fifth day of the operation, as there was a change in the first detection process, the amount of water to be treated in the first treatment process was changed to 2,000 m³/day, and the amount of water to be treated in the second treatment process was changed to 2,000 m³/day. At this time, the T-N concentration measured by the first treated water quality measurement device 8 was 10 mg/L, and the T-N concentration measured by the second treated water quality measurement device 9 was 30 mg/L, without change. As a result of calculation based on the above expression again, as the amount of the second treated water without making the T-N concentration of the mixed water exceed 20 mg/L was 2,000 m³/day, an entire amount of the second treated water W4 was mixed with the first treated water W3 and discharged.

On the sixth day and the seventh day of the operation, as there was a further change in the first detection process, the amount of water to be treated in the first treatment process was changed to 3,000 m³/day, and the amount of water to be treated in the second treatment process was changed to 1,000 m³/day. At this time, the T-N concentration measured by the first treated water quality measurement device 8 was 10 mg/L, and the T-N concentration measured by the second treated water quality measurement device 9 was 30 mg/L, without change. As a result of calculation based on the above expression again, as the amount of the second treated water without making the T-N concentration of the mixed water exceed 20 mg/L was 3,000 m³/day, an entire amount of 1,000 m³ of the second treated water W4 was mixed with the first treated water W3 and discharged, and 2,000 m³ of the second treated water W4 reserved in the intermediate tank was mixed with the first treated water W3 and discharged.

On the eighth day of the operation, as the result of the first detection process was restored to a normal range, an entire amount of the treatment subject water W1 was treated in the first treatment process. At this time, the T-N concentration measured by the first treated water quality measurement device 8 was 10 mg/L, and the T-N concentration measured by the second treated water quality measurement device 9 was 30 mg/L. As this numerically means that 4,000 m³/day of the second treated water W4 may be mixed, the remaining 2,000 m³ of the second treated water W4 reserved in the intermediate tank was mixed with the first treated water W3 and discharged. At this time, the T-N concentration measured by the mixed water quality measurement device 10 was 17 mg/L. With this, it was possible to perform conversion into water satisfying the water quality standard, and to discharge the treated water W5.

### Example 5

In the fresh water-generating device WPE illustrated in FIG. 1, in order to maintain the quality of effluent water appropriately when the second treatment process is selected, it is possible to employ a method of treatment of detecting the quality of the mixed water by the mixed water quality measurement device 10, and adjusting the mixing ratio of the second treated water W4 to the first treated water W3 according to the detection result. This method will be described.

Also in this example, the continuous standard polluted sludge treatment was used as the biological reaction treatment, and the pressure-type hollow yarn ultrafiltration membrane was used as the second solid-liquid separation unit 3. Further, as a standard for the water quality as indicators for controlling the treatment process, the SS concentration was used for suspended matters, and the T-N concentration was used for dissolved matters.

An amount of the influent water, when the treatment was started, to the biological treatment unit 1 that performs the continuous standard polluted sludge treatment was 4,000 m³/day, an SS concentration standard value of the mixed water allowed to be discharged was set to be 30 mg/L, and a T-N concentration standard value of the mixed water allowed to be discharged was set to be 20 mg/L.

The SS concentration and the T-N concentration measured by the mixed water quality measurement device 10 and the amount of the second treated water W4 to be mixed with the first treated water W3 during the treatment period for the treatment subject water are shown in Table 2.

TABLE 2

| | Value measured by | Amount of | Value measured by | | |
|---|---|---|---|---|---|
| | mixed water quality | second | mixed water quality | | |
| | measurement | treated | measurement | | Effluent |
| | device (10) (before | water to | device (10) (after | Final | standard |
| | adjustment of mixing | be mixed | adjustment of mixing | value | value |
| | amount) (mg/L) | (m³/day) | amount) (mg/L) | (mg/L) | (mg/L) |
| SS | 50 | 2000 | 5 | 20 | 30 |
| concentration | | | | | |
| T-N | 30 | 1000 | 15 | 15 | 20 |
| concentration | | | | | |

Immediately after starting the operation, due to a trouble in the biological treatment unit 1, 2,000 m³/day of the treatment subject water W1 was treated in the second treatment process. As the SS concentration was monitored by the mixed water quality measurement device 10 immediately before the discharge, an SS concentration of 50 mg/L exceeding the effluent standard value was measured. As the SS concentration is an indicator of the water quality for suspended matters, as a result of adjustment for increasing the amount of the second treated water W4 to be mixed with the first treated water W3 and 2,000 m³/day of the second treated water W4 was mixed with the first treated water W3, the SS concentration of the mixed water decreased down to 5 mg/L, sufficiently satisfying the quality of effluent water.

On the other hand, when the T-N concentration was then monitored, a T-N concentration of 30 mg/L exceeding the effluent standard value was measured. As the T-N concentration is an indicator of the water quality for dissolved matters, as a result of adjustment for decreasing the amount of the second treated water W4 to be mixed with the first treated water W3 and only 1,000 m³/day of the second treated water W4 was mixed with the first treated water W3, the T-N concentration of the mixed water decreased down to 15 mg/L, sufficiently satisfying the quality of effluent water. By performing such a treatment, final values of the water quality were 20 mg/L for the SS concentration and 15 mg/L for the T-N concentration, and it was possible to discharge the treated water W5 satisfying the quality standard of effluent water into the environment.

The fresh water generation method according to the present invention may be used as a method for purifying sewage and wastewater when the quality of the treated water suddenly deteriorates due to deterioration of the function of the biological treatment in a disaster or a trouble in an operation, or a sudden increase of influent sewage and wastewater in the rain and such.

### DESCRIPTION OF REFERENCE SIGNS

1: biological treatment unit
2: first solid-liquid separation unit
3: second solid-liquid separation unit
4: BOD concentration measurement device
5: MLSS measurement device
6: OUR measurement device
7: biologically treated water quality measurement device
8: first treated water quality measurement device
9: second treated water quality measurement device
10: mixed water quality measurement device
B1: branch point
C1: connection point
L1: treatment subject water flow line
L2: biologically treated water flow line
L3: first treated water flow line
L4: treatment subject water flow line
L5: second treated water flow line
L6: discharge line
V1, V2, V3, V4: valve
W1: treatment subject water
W2: biologically treated water
W3: first treated water
W4: second treated water
W5: treated water
WPE: fresh water-generating device

1. A fresh water generation method for generating treated water by treating sewage and wastewater or treatment subject water as sewage and wastewater that has been previously subjected to a solid-liquid separation treatment, the method comprising:
(a) using a fresh water-generating device including a biological treatment unit configured to treat the treatment subject water that has entered with activated sludge to discharge biologically treated water, a first solid-liquid separation unit configured to treat the biologically treated water that has entered with a solid-liquid separation element to discharge first treated water, and a second solid-liquid separation unit configured to treat the treatment subject water that has entered with a solid-liquid separation element to discharge second treated water;
(b) performing a first detection process for detecting a level of a treatment capacity of the biological treatment unit, and/or a second detection process for detecting either a level of a quality of the first treated water and a level of a quality of the second treated water, or a level of a quality of third treated water as a mixture of the first treated water and the second treated water; and
(c) controlling a volume of the treatment subject water to be treated by the second solid-liquid separation unit, based on the level of the treatment capacity of the biological treatment unit detected in the first detection process, and/or controlling an amount of the second treated water to be mixed with the first treated water, based on the level of the quality of the treated water detected in the second detection process.

2. The fresh water generation method according to claim 1, wherein
the detection of the level of the treatment capacity of the biological treatment unit in the first detection process is made by detecting a level of treatment activity of the activated sludge, and
when the detected level of the treatment activity of the activated sludge fails to satisfy a standard value, an amount of the treatment subject water entering the second solid-liquid separation unit is increased so that the standard value is satisfied.

3. The fresh water generation method according to claim 1, wherein
the detection of the level of the treatment capacity of the biological treatment unit in the first detection process is made by detecting a level of a quality of the biologically treated water, and
when the detected level of the quality of the biologically treated water fails to satisfy a standard value, an amount of the treatment subject water entering the second solid-liquid separation unit is increased so that the standard value is satisfied.

4. The fresh water generation method according to claim 1, wherein
the detection of the level of the treatment capacity of the biological treatment unit in the first detection process is made by detecting a level of treatment activity of the activated sludge, and as well as by detecting a level of a quality of the biologically treated water, and
when the detected level of the treatment activity of the activated sludge and the detected level of the quality of the biologically treated water fail to satisfy a standard value, an amount of the treatment subject water entering the second solid-liquid separation unit is increased so that the standard value is satisfied.

5. The fresh water generation method according to claim 1, wherein
the detection of the level of the quality of the treated water in the second detection process is made by detecting the level of the quality of the third treated water as the mixture of the first treated water and the second treated water, and
when the detected level of the quality of the third treated water fails to satisfy a standard value, the amount of the second treated water to be mixed with the first treated water is controlled so that the standard value is satisfied.

6. The fresh water generation method according to claim 5, wherein
when the detected level of the quality of the third treated water is attributed to a suspended matter in the third treated water, the amount of the second treated water to be mixed with the first treated water is increased, and
when the detected level of the quality of the third treated water is attributed to a dissolved matter in the third treated water, the amount of the second treated water to be mixed with the first treated water is decreased.

7. The fresh water generation method according to claim 2, wherein
the detection of the level of the treatment activity of the activated sludge is made by detecting a level of at least one of BOD sludge loading and OUR of the activated sludge, and
when the detected level of the at least one of BOD sludge loading and OUR exceeds a standard value, the amount of the treatment subject water entering the second solid-liquid separation unit is increased so that the detected level does not exceed the standard value.

8. The fresh water generation method according to claim 1, wherein
the detection of the level of the treatment capacity of the biological treatment unit in the first detection process is made by detecting one or more of BOD, COD, SS concentration, T-P concentration, T-N concentration, and turbidity of the biologically treated water, and
when a detected level of the one or more of BOD, COD, SS concentration, T-P concentration, T-N concentration, and turbidity exceeds a standard value, the amount of the treatment subject water entering the second solid-liquid separation unit is increased so that the detected level does not exceed the standard value.

9. The fresh water generation method according to claim 1, wherein
the detection of the level of the quality of the treated water in the second detection process is made by detecting one or more of BOD, COD, SS concentration, T-P concentration, T-N concentration, and turbidity of the treated water, and
the amount of the second treated water to be mixed with the first treated water is controlled so that the detected level of the one or more of BOD, COD, SS concentration, T-P concentration, T-N concentration, and turbidity satisfies a standard value.

10. The fresh water generation method according to claim 5, wherein
a part of the second treated water is temporarily reserved according to the level of the quality of the third treated water, and
the temporarily reserved second treated water is mixed with the first treated water according to a change in the level of the quality of the third treated water.

11. The fresh water generation method according to claim 1, wherein
the solid-liquid separation element of the second solid-liquid separation unit is made of a filtration membrane.
